(19) United States
(12) Patent Application Publication
(10) Pub. No.: US 2005/0076854 A1
(43) Pub. Date: Apr. 14, 2005

(54) Pet enclosure

(76) Inventors: Richard E. Passno, Sparta, TN (US); Matthew Fayette, Smithville, TN (US)

Correspondence Address: LITMAN LAW OFFICES, LTD., P.O. BOX 15035 CRYSTAL CITY STATION, ARLINGTON, VA, 22215, US

(21) Appl. No.: 10/682,342

(22) Filed: Oct. 10, 2003

(51) Int. Cl. A01K 1/02

(52) U.S. Cl. 119/500; 119/498

(57) ABSTRACT

A pet enclosure for attractively displaying a pet and providing heating, cooling or air circulation as needed is constructed of several panels. A floor panel, side panels, front viewing panel structure including a window, and a cover panel are attached together using trim strips, the trim strips can be further attached to the panels using screws or adhesive. Preferably the trim strips are made of aluminum and the non-window panels are made of two to three-inch thick foam panels with outer skins.

### BACKGROUND OF THE INVENTION

1. Field of the Invention

The present invention relates to pet enclosures and more particularly, to a pet enclosure which is easily constructed to be attractive, easily cleaned, and which can be further modified to include lighting, heating, ventilation and/or to simulate a natural environment.

2. Description of the Related Art

The present invention fulfills a need to provide a pet enclosure that displays a pet in an attractive environment and also simulates a natural environment. This is achieved by the construction set forth below, most particularly, the assembly of skinned foam panels with aluminum trims.

Related art is as follows.

U.S. Pat. No. 4,552,093, issued to Puckett on Nov. 12, 1985, teaches an animal enclosure having removable transparent side panels to obtain access into and to clean the interior without the need to remove the pet. The enclosure provides for filtered fresh air to circulate and can include features of a natural environment, e.g., natural tree branches for bird pets and a replaceable floor tray treated with grass seed.

U.S. Pat. No. 4,844,016, issued to Filosa on Jul. 4, 1989, discloses a pet enclosure having four transparent sides and a transparent cover for displaying and viewing the pet.

U.S. Pat. No. 5,522,344, issued to Demurjian on Jun. 4, 1996, shows a collapsible pet enclosure that uses a pleated accordian-like door and mesh screen sides and top.

Japanese Patent No. 8-9815, published on Jan. 16, 1996, discloses producing a simple doghouse by bending a metallic main wall plate in the form of a box and combining the box with a front cage door.

U.S. Pat. No. 6,394,035, issued to Hill on May 28, 2002, discloses a pet enclosure having a door with a pet portal secured to an enclosure body with a plurality of panels. An access tunnel is secured to the enclosure between the door and one of the panels.

U.S. Pat. No. 6,390,025, issued to Babcock et al. on May 21, 2002, discloses a lightweight cage composed of a plurality of panels. The panel arrangement is fixedly assembled by chemical fusion to define the enclosed space in which the organism is to be kept.

U.S. Pat. No. 5,669,233, issued to Cook et al., discloses a collapsible and reusable container. The container comprises a series of inner insulated panels and an outer enclosure.

U.S. Pat. No. 3,890,932, issued to Sanzone et al. on Jun. 24, 1975, discloses a collapsible container and latching member. The collapsible container comprises a plurality of walls and a wire mesh screen for attaching to the front wall.

U.S. Patent Publication No. 2002/0152969, published on Oct. 24, 2002, discloses a pet enclosure having a decorative exterior cabinet with a padded lower portion for pet comfort. An upper ventilation portion is included to supply air to the pet inside.

U.S. Design Pat. No. 467,040, issued to Bunting on Dec. 10, 2002, discloses the ornamental design for an air-conditioned doghouse.

All of these patents show arrangements for pet enclosures, but they all lack the structural features of the present invention, including the particular panel and trim arrangements described below.

None of the above inventions and patents, taken either singly or in combination, is seen to describe the instant invention as claimed. Thus a pet enclosure solving the aforementioned problems is desired.

### SUMMARY OF THE INVENTION

The invention is directed to pet enclosures, in particular, to a pet enclosure that can display the pet in an attractive setting. The pet enclosure is made from panels that are attached together with trim strips. The panels can be made of any suitable structural material, including window glass or plastic panes for the transparent portions, and 2-3″ foam panels with outer skins for the opaque panels. The trim portions that interconnect the panels are preferably made of aluminum strips.

Accordingly, it is a principal object of the invention to provide a pet enclosure that displays the pet in an attractive setting.

It is another object of the invention to provide a pet enclosure that is made of interconnected panels and trim strips.

It is a further object of the invention to provide a pet enclosure in which panels are made of skinned foam panels and aluminum trim.

Still another object of the invention is to provide a pet enclosure that can be heated or cooled as needed and in which air can be circulated.

Still another object of the invention is to provide a pet enclosure in which transparent panels made of glass or Polyglass are provided to view the pet.

Still another object of the invention is to provide a pet enclosure having an optional mesh insert in the cover for air circulation.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a pet enclosure according to the present invention.

FIG. 2 is an exploded perspective view of the pet enclosure according to the present invention showing the manner of connecting the panels and trim strips.

Similar reference characters denote corresponding features consistently throughout the attached drawings.

### DETAILED DESCRIPTION OF THE PREFERRED EMBODIMENTS

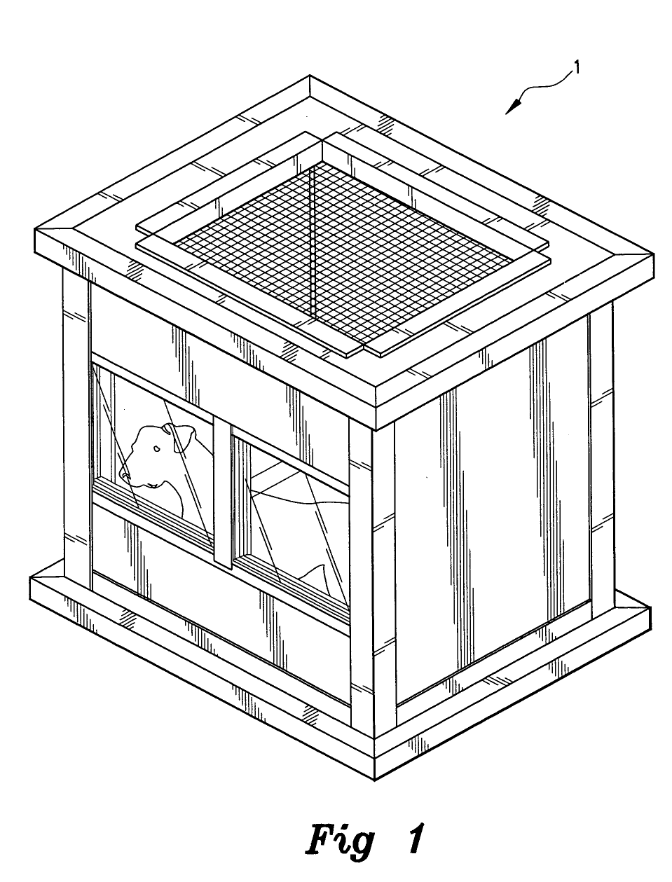

The present invention is a pet enclosure having a viewing panel and an optional mesh screen in its cover. As shown in FIG. 1, a pet, in this case a dog, is visible through the front transparent side panels of the enclosure, 1.

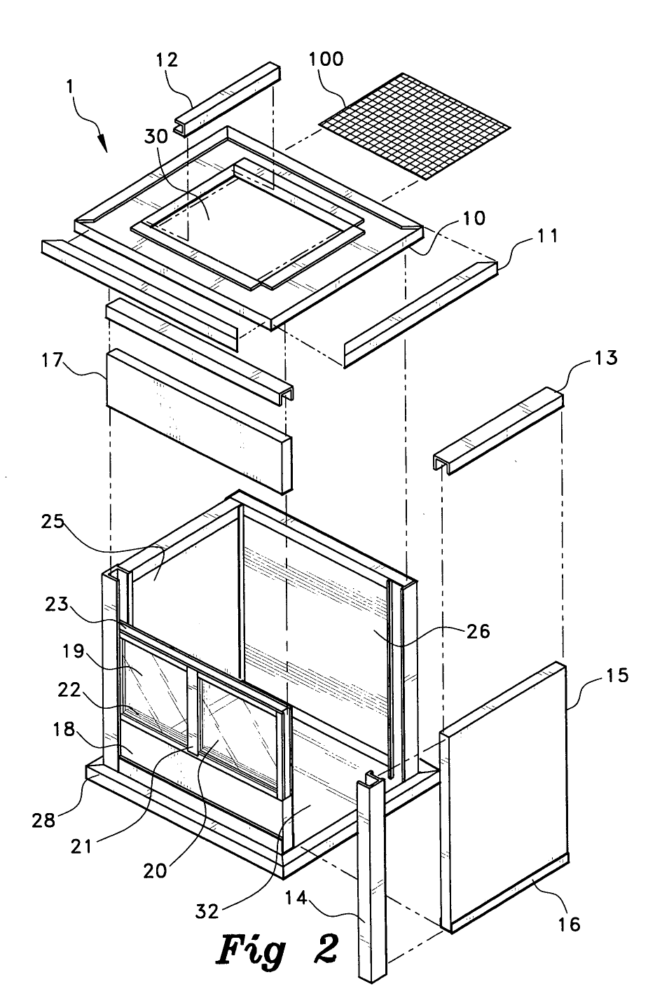

FIG. 2 shows the particular elements of the pet enclosure that are assembled together. The construction includes side panels, i.e., 15, 25 and 26, that are fastened together using trim elements, e.g., upper trim strips 13 and vertical edge trim strips 14. The transparent panels, 19 and 20, are used for viewing the pet.

As shown in FIG. 2, the construction of the pet enclosure begins with floor panel 32 and four aluminum trim strips 28 placed on each of the edges of the floor panel 32. The trim strips can be fastened to the panels by screws or adhesive. Four lower trim strips 16 are then fastened to the floor panel 32 in the arrangement shown, to provide channels to hold the side panels. Four corner trim strips 14 connect the vertical edges of the two side panels, 15 and 25, lower front panel 18 and rear panel 26.

The front of the enclosure has a lower panel 18, an upper panel 17, two windowpanes, 19 and 20, a window trim 21, windowsill 22 and an upper window sash 23.

After all four sides of the enclosure are attached together, the four top trim strips 13 are fastened to the respective tops of the four vertical panels. The four outer edges of cover panel 10 are then covered by trim strips 11 and the inner edges of the opening 30 of the cover panel 10 are covered with trim strips 12. A mesh screen 100 is attached to the opening from the underneath using screws or adhesive. Finally, the cover panel 10 with its inner and outer edges covered by the trim strips and the mesh screen 100 is attached to the top trim strips 13 using screws or adhesive.

The panels are made from any suitable structural material. Preferably, the non-transparent panels are foam panels with an outer skin material disposed on the foam. The skin material may be any suitably attractive material including, but not limited to, aluminum, wood pattern and vinyl. According to the preferred embodiments of the present invention the foam panels have a thickness of 2-3″. The fastening trim strips are preferably made from aluminum.

The completed structure is a sufficiently sturdy construction to provide an enclosure for most household pets.

It is to be understood that the present invention is not limited to the sole embodiments described above, but encompasses any and all embodiments within the scope of the following claims.

1. A pet enclosure, comprising:
a plurality of interconnectable, generally rectangular, non-transparent panels forming a box shaped enclosure having a top, a bottom and a plurality of sidewalls;
a window assembly disposed along at least one of said sidewalls;
an access opening disposed on one of said non-transparent panels;
a mesh screen disposed over the access opening to allow air to ventilate the pet enclosure; and
a plurality of panel fasteners for securing together said plurality of non-transparent panels.

2. The pet enclosure according to claim 1, wherein said plurality of non-transparent panels comprises:
a horizontally oriented floor panel;
two vertically oriented side panels;
a vertically oriented rear panel;
a vertically oriented front panel assembly having an upper front panel and a lower front panel defining an open space between them; and
a horizontally oriented top cover panel;
wherein said vertically oriented panels are disposed along and extend upwardly from the floor panel, said top cover panel being disposed on top of said vertically oriented panels.

3. The pet enclosure according to claim 2, wherein said access opening is disposed on said top cover panel.

4. The pet enclosure according to claim 2, wherein said window assembly is disposed in the open space defined between the upper front panel and the lower front panel.

5. The pet enclosure according to claim 1, wherein said window assembly comprises:
a pair of interconnectable, generally rectangular transparent panels;
a panel fastener for securing said transparent panels to one another;
a window sill disposed along a bottom portion of said transparent panels; and
a window sash disposed along a top portion of said transparent panels.

6. The pet enclosure according to claim 1, wherein said panel fasteners comprise:
a plurality of horizontally oriented single edge trim strips, each strip having a generally U-shaped cross-section to engage a horizontal edge of a panel; and
a plurality of vertical edge connecting trim strips adapted to fasten together pairs of vertical edges of said panels.

7. The pet enclosure according to claim 6, wherein said panel fasteners are aluminum trim strips.

8. The pet enclosure according to claim 1, wherein said non-transparent panels are foam panels having an outer skin disposed thereon.

9. The pet enclosure according to claim 8, wherein said outer skin is selected from the group consisting of vinyl, aluminum, and wood pattern.

10. A pet enclosure, comprising:
a horizontal floor panel structure;
two vertical side panel structures;
a vertical rear panel structure;
a vertical front panel structure including a lower panel, an upper panel and an intermediate window;
a horizontal top cover panel structure;
eight horizontal single edge trim strips, each single edge trim strip having a generally U-shaped cross-section to contain a horizontal edge of a panel or panel structure; and
four vertical edge connecting trim strips to fasten together pairs of vertical edges of the panels and panel structures;
wherein the two vertical side panel structures, the front and the rear vertical panel structures are held together using the four vertical edge connecting trim strips to obtain an enclosure and, wherein, the top cover panel structure is attached to the tops of the vertical panel structures using single edge trim strips.

11. The pet enclosure according to claim 10, wherein said trim strips are aluminum.

12. The pet enclosure according to claim 10, wherein said panels are foam panels having an outer skin disposed thereon.

13. The pet enclosure according to claim 12, wherein said outer skin is selected from the group consisting of vinyl, aluminum and wood pattern.
